(19) United States
(12) Patent Application Publication
(10) Pub. No.: US 2025/0310509 A1
(43) Pub. Date: Oct. 2, 2025

(54) METHOD, APPARATUS, ELECTRONIC DEVICE, AND STORAGE MEDIUM FOR DISPLAYING 3D IMAGE

(71) Applicant: Beijing Zitiao Network Technology Co., Ltd., Beijing (CN)

(72) Inventors: Wenju SONG, Beijing (CN); Fukang LIU, Beijing (CN)

(21) Appl. No.: 19/079,296

(22) Filed: Mar. 13, 2025

(30) Foreign Application Priority Data
Mar. 29, 2024 (CN) 202410382023.7

(51) Int. Cl. H04N 13/351; G06T 19/20; H04N 13/00; H04N 13/128

(52) U.S. Cl. CPC H04N 13/351; G06T 19/20; H04N 13/128; G06T 2219/2004; G06T 2219/2016; H04N 2013/0081

(57) ABSTRACT

Provided are a method, an electronic device, and a storage medium for displaying a 3D image. The method includes: obtaining a left-eye image and a right-eye image based on a 3D image, and rendering the left-eye image and the right-eye image; and drawing the rendered left-eye image into the first graphics buffer based on a first layer corresponding to a first display generation component to present the left-eye image on the first display generation component through a first application interface of the target 2D application, and drawing the rendered right-eye image into the first graphics buffer based on a second layer corresponding to a second display generation component to present a picture of the right-eye image on the second display generation component through the first application interface of the target 2D application.

### CROSS-REFERENCE TO RELATED APPLICATION(S)

This application claims priority to Chinese Application No. 202410382023.7 filed on Mar. 29, 2024,the disclosure of which is incorporated herein by reference in its entirety.

### FIELD

The present disclosure relates to the field of computer technology, and in particular, to a method, an apparatus, an electronic device, and a storage medium for displaying a three-dimensional (3D) image.

### BACKGROUND

Extended reality (XR) technology can combine the real with the virtual through a computer to provide a user with a 3D environment for human-computer interaction.

### SUMMARY

The Summary section is provided to introduce concepts in a brief form that are described in detail in the following Detailed Description section. This Summary section is not intended to identify key features or essential features of the claimed technical solution, nor is it intended to be used to limit the scope of the claimed technical solution.

According to one or more embodiments of the present disclosure, a first aspect provides a method for displaying a three-dimensional (3D) image, including: performing, at an electronic device in communication with a first display generation component, a second display generation component, and an input device, the following steps: displaying, by the first display generation component and the second display generation component, a computer-generated 3D environment; detecting, by the input device, a preset operation of a user for the 3D image; invoking a target 2D application in response to the preset operation; creating a first graphics buffer corresponding to the target 2D application; obtaining a left-eye image and a right-eye image based on the 3D image, rendering the left-eye image and the right-eye image; and drawing the rendered left-eye image into the first graphics buffer based on a first layer corresponding to the first display generation component to present a picture of the left-eye image on the first display generation component through a first application interface of the target 2D application, and drawing the rendered right-eye image into the first graphics buffer based on a second layer corresponding to the second display generation component to present a picture of the right-eye image on the second display generation component through the first application interface of the target 2D application.

According to one or more embodiments of the present disclosure, a second aspect provides an apparatus for displaying a 3D image, including: a display unit, configured to display a computer-generated 3D environment; an operation detection unit, configured to detect, by the input device, a preset operation of a user for the 3D image; an application invoking unit, configured to invoke a target 2D application in response to the preset operation; a buffer creation unit, configured to create a first graphics buffer corresponding to the target 2D application; an image parsing unit, configured to obtain a left-eye image and a right-eye image based on the 3D image, an image rendering unit, configured to render the left-eye image and the right-eye image; and an image drawing unit, configured to draw the rendered left-eye image into the first graphics buffer based on a first layer corresponding to the first display generation component to present a picture of the left-eye image on the first display generation component through a first application interface of the target 2D application, and draw the rendered right-eye image into the first graphics buffer based on a second layer corresponding to the second display generation component to present a picture of the right-eye image on the second display generation component through the first application interface of the target 2D application.

According to one or more embodiments of the present disclosure, a third aspect provides an electronic device, including: at least one memory and at least one processor; where the memory is configured to store program code, and the processor is configured to invoke the program code stored in the memory to cause the electronic device to perform the method for displaying a 3D image provided according to one or more embodiments of the present disclosure.

According to one or more embodiments of the present disclosure, a fourth aspect provides a non-transitory computer storage medium, where the non-transitory computer storage medium stores program code, and the program code, when executed by a computer device, causes the computer device to perform the method for displaying a 3D image provided according to one or more embodiments of the present disclosure.

According to one or more embodiments of the present disclosure, by invoking a target 2D application in response to a preset operation of a user for a 3D image, creating a first graphics buffer for the target 2D application, and drawing rendered left and right-eye images into the first graphics buffer based on a first layer corresponding to a first display generation component and a second layer corresponding to a second display generation component respectively, to present the left and right-eye images on the first and second display generation components respectively through a first application interface of the 2D application, a 3D visual effect can be presented through the 2D application in an XR device.

### BRIEF DESCRIPTION OF THE DRAWINGS

The above and other features, advantages, and aspects of various embodiments of the present disclosure will become more apparent with reference to the following specific embodiments and in conjunction with the drawings. Throughout the drawings, the same or similar reference numbers refer to the same or similar elements. It should be understood that the drawings are schematic and that the components and elements are not necessarily drawn to scale.

FIG. 1 is an exemplary schematic diagram of a virtual field of view of an extended reality device provided according to some embodiments of the present disclosure;

FIG. 2 is a schematic flowchart of a method for displaying a 3D image provided according to some embodiments of the present disclosure;

FIG. 3 is a schematic flowchart of a method for displaying a 3D image provided according to another embodiment of the present disclosure;

FIG. 4 is a schematic flowchart of a method for displaying a 3D image provided according to yet another embodiment of the present disclosure;

FIG. 5 is a schematic structural diagram of an apparatus for displaying a 3D image provided according to some embodiments of the present disclosure; and

FIG. 6 is a schematic structural diagram of an electronic device provided according to some embodiments of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that the steps described in the implementations of the present disclosure may be performed in different orders, and/or performed in parallel. Furthermore, the implementations may include additional steps and/or omit performing the illustrated steps. The scope of the present disclosure is not limited in this respect.

The term “include/include” and its variants as used herein are open-ended inclusions, that is, “include/include but not limited to”. The term “based on” is “at least partially based on”. The term “an embodiment” means “at least one embodiment”. The term “another embodiment” means “at least one other embodiment”. The term “some embodiments” means “at least some embodiments”. The term “in response to” and related terms refer to a signal or event being affected by another signal or event to some extent, but not necessarily completely or directly. If event x occurs “in response to” event y, then x may be in response to y directly or indirectly. For example, the occurrence of y may ultimately lead to the occurrence of x, but there may be other intermediate events and/or conditions. In other cases, y may not necessarily lead to the occurrence of x, and x may occur even if y has not occurred. Furthermore, the term “in response to” may also mean “at least partially in response to”.

The term “determine/determination” generally encompasses a variety of actions, which may include acquiring, calculating, computing, processing, deriving, researching, searching (for example, searching in a table, database, or other data structure), exploring, and similar actions, and may also include receiving (for example, receiving information), accessing (for example, accessing data in a memory), and similar actions, as well as parsing, selecting, choosing, establishing, and similar actions, among others. Related definitions of other terms will be given in the following description.

It should be noted that concepts such as “first” and “second” mentioned in the present disclosure are only used to distinguish different apparatuses, modules, or units, and are not used to limit the sequence or interdependence of functions performed by these apparatuses, modules, or units.

It should be noted that the modifiers “one” and “multiple” mentioned in the present disclosure are illustrative rather than restrictive, and those skilled in the art should understand that unless the context clearly indicates otherwise, they should be understood as “one or more”.

For the purposes of the present disclosure, the phrase “A and/or B” means (A), (B) or (A and B).

The names of messages or information exchanged between multiple apparatuses in the implementations of the present disclosure are only for illustrative purposes, and are not intended to limit the scope of these messages or information.

It should be noted that the step of acquiring the user's personal data mentioned in the present disclosure is performed with the user's authorization. For example, in response to receiving an active request from the user, prompt information is is sent to the user to clearly inform the user that the operation requested by the will require the acquisition and use of the user's personal information. Thus, the user can independently choose whether to provide personal information to software or hardware such as an electronic device, an application, a server, or a storage medium that performs the operations of the technical solution of the present disclosure according to the prompt information. As an optional but non-limiting implementation, the manner of sending the prompt information to the user in response to receiving the user's active request may be, for example, a pop-up window, and the prompt information may be presented in text in the pop-up window. In addition, the pop-up window may also carry a selection control for the user to choose “agree” or “disagree” to provide personal information to the electronic device. It can be understood that the above process of notifying and acquiring the user's authorization is only illustrative, and does not constitute a limitation on the implementations of the present disclosure. Other methods that meet relevant laws and regulations may also be applied to the implementations of the present disclosure. It can be understood that the data involved in the technical solution (including but not limited to the data itself, the acquisition or use of the data) should comply with the requirements of corresponding laws, regulations and related regulations.

Extended reality (XR) technology can combine the real world with the virtual world through a computer to provide a user with a 3D environment for human-computer interaction. In the virtual reality space, the user can use the extended reality device such as a head-mounted display (HMD) for social interaction, entertainment, study, work, telecommuting, creation of user generated content (UGC), and the like. The user can use the extended reality device such as the head-mounted display to enter the virtual reality space, and control his/her virtual character (avatar) in the virtual reality space to conduct social interaction, entertainment, study, telecommuting, and the like with virtual characters controlled by other users.

The extended reality device described in the embodiments of the present disclosure may include, but are not limited to, the following types:

A personal computer virtual reality (PCVR) device, which computes relevant functions of the extended reality and outputs data using a PC end, and an external PCVR device uses data output by the PC end to achieve an effect of extended reality.

A mobile extended reality device, which supports setting a mobile terminal (such as a smart phone) in various ways (such as a head-mounted display provided with a dedicated card slot), and performs relevant computations of an extended reality function by the mobile terminal through a wired or wireless connection to the mobile terminal, and outputs data to the mobile extended reality device, for example, to watch an extended reality video through an APP of the mobile terminal.

The all-in-one extended reality device has a processor for performing relevant computations of a virtual function, and thus has independent functions of extended reality input and output, does not need to be connected to a PC end or a mobile terminal, and has high use freedom.

Of course, the implementation form of the extended reality device is not limited to this, and it can be further miniaturized or enlarged according to requirements.

The extended reality device is provided with a sensor (such as a nine-axis sensor) for posture detection, which is used to detect posture changes of the extended reality device in real time. If a user wears the extended reality device, when the user's head posture changes, a real-time posture of the head can be transmitted to the processor, so as to calculate a gaze point of the user's sight line in the virtual environment, calculate an image within the user's gaze range (i.e., the virtual field of view) in the 3D model of the virtual environment based on the gaze point, and display the image on the display screen, so that the user can have an immersive experience as if they were in a real environment.

Presenting a 3D visual effect in an XR device usually needs to be implemented by a specialized 3D development tool, which renders different depths of field for left and right eyes to synthesize a 3D stereoscopic effect. However, for applications that require a lot of interaction with users, some 3D development tools have problems such as slow startup, few development tools, and low development efficiency.

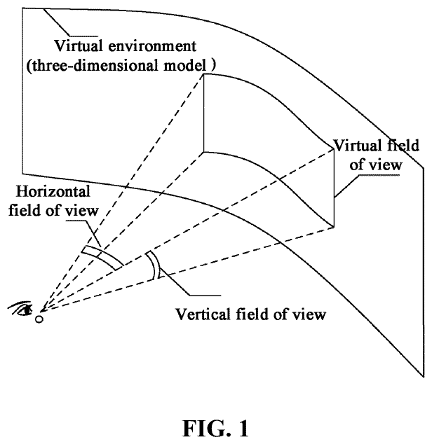

FIG. 1 is an exemplary schematic diagram of a virtual field of view of an extended reality device provided according to some embodiments of the present disclosure. The extent of the virtual field of view in the virtual environment is defined using a horizontal field of view and a vertical field of view. The extent in the vertical direction is represented by a vertical field of view BOC, and the extent in the horizontal direction is represented by a horizontal field of view AOB. The human eye can always perceive an image located in the virtual field of view in the virtual environment through a lens. It can be understood that the larger the field of view, the larger the size of the virtual field of view and the larger the area of the virtual environment that the user can perceive. The field of view represents the extent of observation angle when an environment is perceived through a lens. For example, the field of view of the extended reality device represents the extent of observation angle of the human eye when the virtual environment is perceived through the lens of the extended reality device. For another example, for a mobile terminal provided with a camera, the field of view of the camera is the extent of observation angle when the camera senses the real environment for shooting.

The extended reality device, such as the HMD, is integrated with several cameras (such as a depth camera, an RGB camera, etc.), and the purpose of the cameras is not limited to providing a see-through view. The camera images and integrated inertial measurement unit (IMU) provide data that can be processed by computer vision methods to automatically analyze and understand the environment. Furthermore, the HMD is designed to support not only passive computer vision analysis, but also active computer vision analysis. Passive computer vision methods analyze image information captured from the environment. These methods may be single-field-of-view (images from a single camera) or stereoscopic (images from two cameras). They include, but are not limited to, feature tracking, object recognition, and depth estimation. Active computer vision methods add information to the environment by projecting patterns that are visible to the camera but not necessarily to the human visual system. Such techniques include time-of-flight (ToF) cameras, laser scanning, or structured light to simplify the stereo matching problem. Active computer vision is used to achieve scene depth reconstruction.

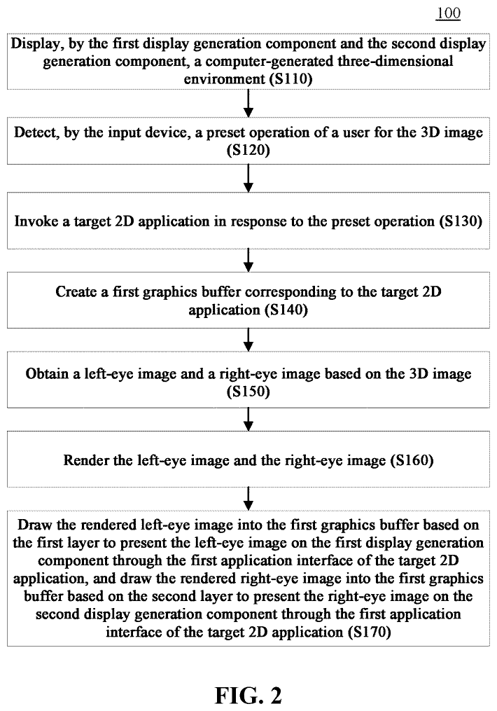

Reference is made to FIG. 2, which illustrates a flowchart of a method 100 for displaying a 3D image provided according to some embodiments of the present disclosure. In some embodiments, the method 100 is performed at an electronic device (such as a head-mounted display), which can communicate with more than two display generation components (such as display screens) and one or more input devices (such as an eye tracking device, a hand tracking device, a camera, or other input devices). In some embodiments, the display generation components may be integrated on the electronic device; and the input device may be integrated on or external to the electronic device. In some embodiments, the input device may be a handheld controller.

The method 100 includes steps S110 to S170.

Step S110: display, by the display generation components, a computer-generated 3D environment.

In some embodiments, the 3D environment (e.g., a virtual reality space) may be an emulation environment of the physical world, a semi-emulation and semi-fictional virtual scene, or a purely fictional virtual scene, which is not limited in the present disclosure. The virtual scene may be any one of a two-dimensional (2D) virtual scene, a 2.5-dimensional (2.5D) virtual scene, or a 3D virtual scene, and the dimension of the virtual scene is not limited in the embodiments of the present application. For example, the virtual scene may include sky, land, ocean, etc., and the land may include environmental elements such as desert, city, etc., and the user may control the virtual object to move in the virtual scene.

Step S120: receive, by the input device, a preset operation of a user for the 3D image.

The 3D image includes a 3D picture or a 3D video. In some embodiments, the user may trigger an instruction for instructing to display the 3D image through a body-sensing control operation, a gesture control operation, an eyeball movement operation, a touch operation, a voice operation, or an operation on an external control device (such as a joystick). The preset operation may be used to open a 3D photo file or a 3D video file, so that the electronic device presents the corresponding 3D image.

In some embodiments, the input device may be a handheld controller, and the user may operate the handheld controller to trigger relevant instructions. In some embodiments, the input device may detect the user's instructions based on a motion-sensing detection method or a computer-vision-based detection method. For example, a pose of a certain body part (such as a hand) of the user may be detected based on a camera (such as a depth camera) through a computer-vision-based motion tracking algorithm, but the present disclosure is not limited thereto. The six degrees of freedom include moving degrees of freedom in directions of three rectangular coordinate axes of x, y, z and rotating degrees of freedom around the three coordinate axes, which are front and rear, up and down, left and right, pitch (pitch), yaw (yaw), and roll (roll), a total of 6 degrees of freedom.

In some embodiments, the HMD is integrated with a hand tracking device, through which hand information of the user, such as user's gestures, may be acquired. The hand tracking device is part of the HMD (for example, embedded in or attached to the head-mounted device).

In some implementations, the hand tracking device includes an image sensor (e.g., one or more infrared cameras, 3D cameras, depth cameras and/or color cameras, etc.) that captures 3D scene information that includes at least a hand of a human user. The image sensor captures images of the hand with sufficient resolution that fingers and their respective positions can be distinguished.

In some embodiments, the HMD is integrated with a gaze tracking device, through which visual information of the user, such as a sight line and a gaze point of the user, may be acquired. In an embodiment, the gaze tracking device includes at least one eye tracking camera (e.g., an infrared (IR) or near infrared (NIR) camera), and an illumination source (e.g., an infrared or near infrared light source, such as an array or ring of LEDs) that emits light (e.g., infrared or near infrared light) toward the eyes of the user. The eye tracking camera may be pointed at the user's eyes to receive infrared or near infrared light directly reflected from the eyes by the light source, or alternatively may be pointed at “hot” mirrors located between the user's eyes and the display panel, which reflect infrared or near infrared light from the eyes to the eye tracking camera while allowing visible light to pass through. The gaze tracking device optionally captures images of the user's eyes (e.g., as a video stream captured at 60 frames per second-120 frames per second (fps)), analyzes these images to generate gaze tracking information, and transmits the gaze tracking information to the HMD, so that some human-computer interaction functions may be completed based on the gaze information of the user, such as implementing content navigation based on the gaze information. In some implementations, both eyes of the user are separately tracked through respective eye tracking cameras and illumination sources. In some implementations, only one eye of the user is tracked through a corresponding eye tracking camera and illumination source.

Step S130: invoke a target 2D application in response to the preset operation.

In some embodiments, the target 2D application may be an application configured to display a 2D image, such as an album application. In this step, the target 2D application may be invoked to load the 3D image in response to the preset operation of the user for the 3D image.

Step S140: create a first graphics buffer corresponding to the target 2D application.

The graphics buffer is used to render an image to be displayed on the screen. In some embodiments, the graphics buffer (such as Surface) may include a memory area (such as a frame buffer) for storing data (such as color, depth, texture, etc.) to be displayed. The application controls its presentation on the screen by writing content to the graphics buffer.

The first graphics buffer is a graphics buffer corresponding to the 2D application, and may be associated with the first layer and the second layer. The first layer corresponds to the first display generation component, and the second layer corresponds to the second display generation component. The first display generation component is used to present an image to the user's left eye, and the second display generation component is used to present image content to the user's right eye. In other words, the user's left eye sees an image presented based on the first layer, and the user's right eye sees an image presented based on the second layer.

In some embodiments, the target 2D application may be an album application, but the present disclosure is not limited thereto.

Step S150: obtain a left-eye image and a right-eye image based on the 3D image.

Step S160: render the left-eye image and the right-eye image.

The reason why human eyes have stereoscopic vision is that there is a deviation between images observed by left and right eyes, and such deviation, after being processed by the brain, generates a sense of depth and distance. Accordingly, the 3D image is usually composed of left and right-eye images. In some embodiments, the format of the 3D image may include a left-right side-by-side format, a top-bottom side-by-side format, an interlaced format, etc., but the present disclosure is not limited thereto.

Step S170: draw the rendered left-eye image into the first graphics buffer based on the first layer to present the left-eye image on the first display generation component through the first application interface of the target 2D application, and draw the rendered right-eye image into the first graphics buffer based on the second layer to present the right-eye image content on the second display generation component through the first application interface of the target 2D application.

In some embodiments, the first application interface is associated with the first graphics buffer, and is used to present content in the first graphics buffer on the screen.

In this step, the left-eye image and the right-eye image may be drawn into the first graphics buffer based on the first layer and the second layer respectively, so that the first display generation component and the second display generation component may present the left-eye image and the right-eye image respectively through the first application interface.

In some embodiments, the left-eye image and the right-eye image may be rendered on the first layer and the second layer respectively, and the first layer and the second layer may be synthesized into the first graphics buffer. The user's left eye sees the content presented by the first layer, and the right eye sees the content presented by the second layer, so that a stereoscopic vision effect may be presented.

In this way, according to one or more embodiments of the present disclosure, by invoking a target 2D application in response to a preset operation of a user for a 3D image, creating a first graphics buffer for the target 2D application, and drawing rendered left and right-eye images into the first graphics buffer based on a first layer and a second layer corresponding to first and second display generation components respectively, to present the left and right-eye images on the first and second display generation components respectively through a first application interface of the 2D application, a 3D visual effect can be presented through the 2D application in an XR device.

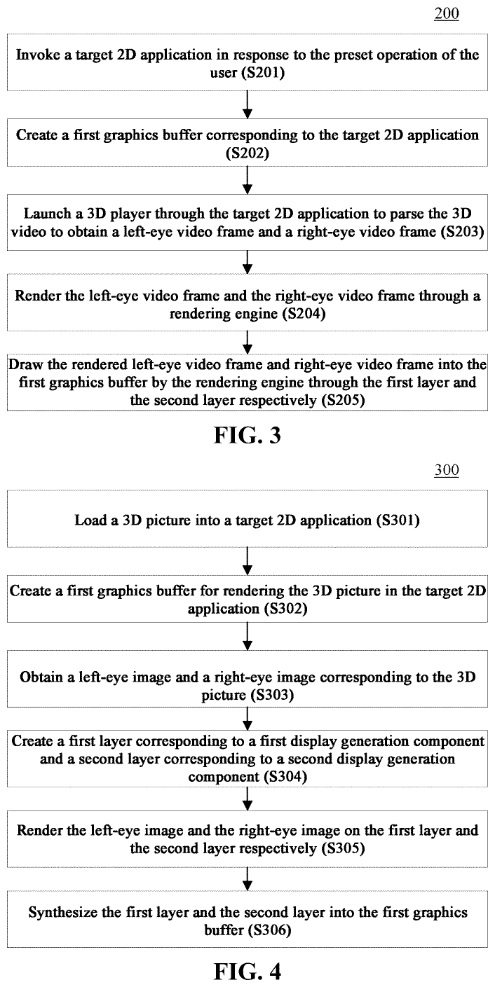

The following takes playing a 3D video through a 2D application as an example for illustration. Reference is made to FIG. 3, which illustrates a flowchart of a method 300 for displaying a 3D image provided according to some embodiments of the present disclosure.

At step 201, a target 2D application is invoked in response to the preset operation of the user.

At step 202, a first graphics buffer corresponding to the target 2D application is created. Exemplarily, the target 2D application applies to a framework layer for a window panel manager, creates the first graphics buffer through the framework layer and binds the first layer and the second layer, and then the framework layer returns the created first graphics buffer to the target 2D application. In some embodiments, the first layer and the second layer may be set to a rendering engine through a window management module for subsequent rendering.

At step 203, a 3D player is launched through the target 2D application to parse the 3D video to obtain a left-eye video frame and a right-eye video frame. The 3D player is a player capable of parsing and packaging the 3D video. Exemplarily, the target 2D application may apply to create the 3D player and bind it to the first graphics buffer, and the 3D player decodes the 3D video to obtain the left-eye video frame and the right-eye video frame corresponding to each frame. In some embodiments, the 3D player may also synthesize the left-eye video frame and the right-eye video frame corresponding to the same frame into an intermediate product (such as buffer) and send it to a rendering engine for rendering, so as to ensure that the left-eye video frame and the right-eye video frame of the same video frame are rendered and displayed on the screen synchronously.

At step 204, the left-eye video frame and the right-eye video frame are rendered through the rendering engine.

At step 205, the rendered left-eye video frame and right-eye video frame are drawn into the first graphics buffer by the rendering engine through the first layer and the second layer respectively.

In this way, the rendered content of the 3D video is transmitted to the 2D application, so that the 3D video may be played through the 2D application. In some embodiments, the 3D image may be returned to the target 2D application from the rendering engine via the window management module.

According to one or more embodiments of the present disclosure, by parsing images of left and right eyes of the 3D video by using the capability of the 3D player, handing them over to the rendering engine for rendering, and then receiving the rendered content by the first graphics buffer of the 2D application, playing the 3D video through the 2D application can be implemented.

In some embodiments, the dynamic disparity information of the 3D video may also be acquired through the 3D player, and the left-eye image and the right-eye image may be rendered based on the dynamic disparity information. Exemplarily, when the 3D player parses the dynamic disparity information, it may call back the information to the target 2D application, and then the target 2D application sends it to the rendering engine at the bottom layer via the application layer and the window management module, and the rendering engine renders the disparity effect. The dynamic disparity information includes disparity information generated due to translation or scaling of a lens during a video capturing process.

The following takes playing a 3D picture through a 2D application as an example for illustration. Reference is made to FIG. 4, which illustrates a flowchart of a method 300 for displaying a 3D image provided according to some embodiments of the present disclosure.

At step 301, a 3D picture is loaded into a target 2D application.

At step 302, a first graphics buffer for rendering the 3D picture is created in the target 2D application.

At step 303, a left-eye picture and a right-eye picture corresponding to the 3D picture are obtained. Exemplarily, for 3D pictures in left-right side-by-side format and top-bottom side-by-side format, the left-eye picture and the right-eye picture may be directly obtained by segmentation.

At step 304, a first layer corresponding to the first display generation component and a second layer corresponding to the second display generation component are created. The first layer and the second layer respectively correspond to the content seen by the user's left eye and right eye. In some embodiments, the first graphics buffer may be bound to the first layer and the second layer.

At step 305, the left-eye picture and the right-eye picture are rendered on the first layer and the second layer respectively.

At step 306, the first layer and the second layer are synthesized into the first graphics buffer. The user's left eye sees the content presented by the first layer, and the right eye sees the content presented by the second layer, so that a stereoscopic vision effect may be presented.

In some embodiments, the target 2D application has a visual element capable of interacting with the user, and the visual element is invisible by default when the 3D image is presented on the first application interface. If the user needs to switch the video, the electronic device may display the target video frame on the visual element and cause the first application interface to be invisible in response to the video switching operation of the user; and after the video switching is completed, cause the visual element to be invisible, and cause the first application interface to be visible, and display the image of the switched video through the first application interface. The target video frame is a video frame displayed by the first application interface when the video switching operation is detected.

Exemplarily, in the 3D environment, the visual element may cover the first application interface, or be disposed between the first application interface and the user, or be disposed in other manners capable of intercepting the interactive operation of the user on the first application interface. The visual element is invisible to the user by default. When the user attempts to operate the first application interface, in response to the video switching operation (e.g., a drag operation) of the user, the target video frame may be displayed on the visual element (that is, the visual element becomes visible), the visual element is moved in the 3D environment, and the first application interface is hidden synchronously. After the video switching is completed (e.g., the user stops the current drag operation), the visual element may be hidden again, the first application interface may be caused to be visible, and the image of the switched video may be displayed through the first application interface. For example, the video may be played directly, or only a static picture of a certain frame of the video may be displayed. In this way, the user may switch the video by dragging the video image.

In some implementations, the visual element may include a control (e.g., View), but the present disclosure is not limited thereto.

In some implementations, the visual element is associated with a second graphics buffer. When the 2D application detects an operation (e.g., a drag operation) on the visual element, it may set the second graphics buffer to a player, and the player draws the video frame currently played by the first application interface into the second graphics buffer. At the same time, the first graphics buffer is hidden. At this time, the second graphics buffer displaying the video frame currently being played will be dragged following the user's operation. After the drag operation is completed, the second graphics buffer is hidden, and the first graphics buffer is set to a display state and the image of the switched video is drawn in the first graphics buffer, so as to implement video switching and display.

In some implementations, the image of the target video frame displayed by the visual element has the same position and size as the video image displayed by the first application interface, so that the video switching animation is more smooth.

The rendering of the graphics buffer is controlled by the underlying system, which is not perceptible to applications, and the video playback window is difficult to move directly in response to user operations. A possible solution is to drag the window through a window manager, but this solution has problems such as cross-process synchronization, error accumulation and reporting, and multi-application debugging. In this regard, according to one or more embodiments of the present disclosure, by switching between displaying the visual element and the first application interface of the 2D application, the video switching animation can be conveniently implemented, which facilitates the user to quickly browse different videos.

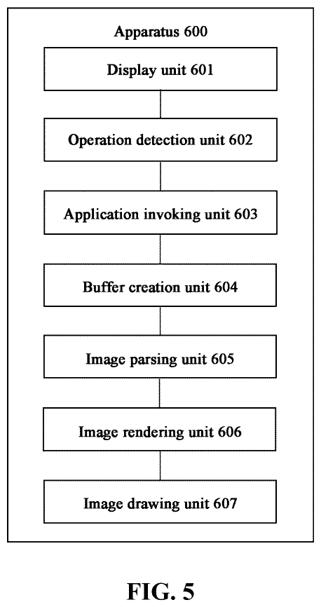

Accordingly, referring to FIG. 5, an apparatus 600 for displaying a 3D image is provided according to some embodiments of the present disclosure, including: a display unit 601, configured to display a computer-generated 3D environment; an operation detection unit 602, configured to detect, by the input device, a preset operation of a user for the 3D image; an application invoking unit 603, configured to invoke a target 2D application in response to the preset operation; a buffer creation unit 604, configured to create a first graphics buffer corresponding to the target 2D application; an image parsing unit 605, configured to obtain a left-eye image and a right-eye image based on the 3D image; an image rendering unit 606, configured to render the left-eye image and the right-eye image; and an image drawing unit 607, configured to draw the rendered left-eye image into the first graphics buffer based on a first layer corresponding to the first display generation component to present a picture of the left-eye image on the first display generation component through a first application interface of the target 2D application, and draw the rendered right-eye image into the first graphics buffer based on a second layer corresponding to the second display generation component to present a picture of the right-eye image on the second display generation component through the first application interface of the target 2D application.

In some embodiments, the 3D image includes a 3D video; the image parsing unit is configured to launch a 3D player through the target 2D application to parse the 3D video to obtain the left-eye image and the right-eye image.

In some embodiments, the apparatus further includes: a disparity acquiring unit, configured to obtain dynamic disparity information of the 3D video based on the 3D player; a disparity rendering unit, configured to render the left-eye image and the right-eye image based on the dynamic disparity information; where the dynamic disparity information includes disparity information generated due to translation or scaling of a lens during a video capturing process.

In some embodiments, the target 2D application has a visual element capable of interacting with a user; the visual element is invisible when the 3D image is presented on the first application interface; the apparatus further includes: a first video switching unit, configured to, in response to a video switching operation of the user, display a target video frame through the visual element and cause the visual element to perform an action corresponding to the video switching operation, and cause the first application interface to be invisible; where the target video frame is a video frame displayed by the first application interface when the video switching operation is detected; and a second video switching unit, configured to, after the video switching is completed, cause the visual element to be invisible, and cause the first application interface to be visible, and display an image of a switched video through the first application interface.

In some embodiments, the displaying the target video frame through the visual element includes: drawing the target video frame in a second graphics buffer corresponding to the visual element; the causing the first application interface to be invisible includes: hiding the first graphics buffer; the causing the visual element to be invisible includes: hiding the second graphics buffer; and the causing the first application interface to be visible and playing the switched video through the first application interface includes: setting the first graphics buffer to a display state, and drawing the image of the switched video in the first graphics buffer.

In some embodiments, a position and a size of the visual element are set to be capable of intercepting an interactive operation of the user on the first application interface.

In some embodiments, the video switching operation includes a drag operation on the visual element; the causing the visual element to perform the action corresponding to the video switching operation includes: moving the visual element in the 3D environment.

With regard to the embodiments of the apparatus, since they basically correspond to the method embodiments, reference may be made to the descriptions of the method embodiments for related parts. The apparatus embodiments described above are only schematic, and the modules described as separate modules may be or may not be separate. Some or all of them may be selected according to actual needs to achieve the purpose of the solution of this embodiment. Those ordinary skilled in the art can understand and implement it without creative work.

Accordingly, according to one or more embodiments of the present disclosure, an electronic device is provided, including: at least one memory and at least one processor; where the memory is configured to store program code, and the processor is configured to invoke the program code stored in the memory to cause the electronic device to perform the method for displaying a 3D image provided according to one or more embodiments of the present disclosure.

Accordingly, according to one or more embodiments of the present disclosure, a non-transitory computer storage medium is provided, where the non-transitory computer storage medium stores program code, and the program code may be executed by a computer device to cause the computer device to perform the method for displaying a 3D image provided according to one or more embodiments of the present disclosure.

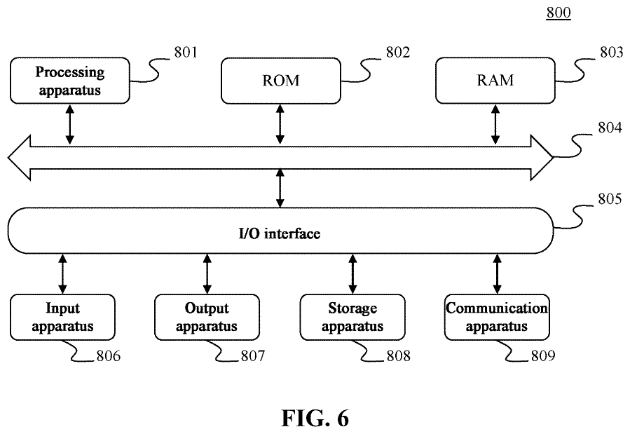

Reference is made to FIG. 6 below, which illustrates a schematic structural diagram of an electronic device 800 (such as a terminal device or a server) suitable for implementing the embodiments of the present disclosure. The terminal device in the embodiments of the present disclosure may include, but are not limited to, mobile terminals such as a mobile phone, a laptop, a digital broadcast receiver, a personal digital assistant (PDA), a tablet computer, a portable multimedia player (PMP), a vehicle-mounted terminal (such as a vehicle-mounted navigation terminal), etc., and fixed terminals such as a digital TV, a desktop computer, etc. The electronic device shown in FIG. 6 is only an example, and should not bring any limitation to the functions and scope of use of the embodiments of the present disclosure.

As shown in FIG. 6, the electronic device 800 may include a processing apparatus (such as a central processing unit, a graphics processing unit, etc.) 801, which may perform various appropriate actions and processing according to a program stored in a read-only memory (ROM) 802 or a program loaded from a storage apparatus 808 into a random-access memory (RAM) 803. The RAM 803 further stores various programs and data required for the operation of the electronic device 800. The processing apparatus 801, ROM 802, and RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touch pad, a keyboard, a mouse, a camera, a microphone, an accelerometer, and a gyroscope; an output apparatus 807 including, for example, a liquid crystal display (LCD), a speaker, and a vibrator; a storage apparatus 808 including, for example, a magnetic tape and a hard disk; and a communication apparatus 809. The communication apparatus 809 may allow the electronic device 800 to be in wireless or wired communication with other devices to exchange data. Although FIG. 6 shows the electronic device 800 having various apparatuses, it should be understood that not all of the illustrated apparatuses are necessarily implemented or included. More or fewer apparatuses may alternatively be implemented or included.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, and the computer program contains program code for executing the method shown in the flowchart. In such embodiments, the computer program may be downloaded and installed from a network through the communication apparatus 809, or installed from the storage apparatus 808, or installed from the ROM 802. When the computer program is executed by the processing apparatus 801, the above-mentioned functions defined in the methods of the embodiments of the present disclosure are performed.

It should be noted that the above-mentioned computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination of the above. More examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal that propagates in a baseband or as a part of a carrier, and carries computer-readable program code therein. The data signal propagating in this manner may take a variety of forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus or device. The program code contained on the computer-readable medium may be transmitted by any suitable medium, including but not limited to: wire, optical cable, RF (radio frequency), etc., or any suitable combination of the above.

In some implementations, the client and the server may communicate using any currently known or future-developed network protocol such as HTTP (Hypertext transfer protocol), and may communicate (via a communication network) and interconnect with digital data in any form or medium. Examples of the communication network include a local area network (“LAN”), a wide area network (“WAN”), the Internet, and an end-to-end network (e.g., an ad hoc end-to-end network), as well as any network currently known or developed in the future.

The above-mentioned computer-readable medium may be included in the above-mentioned electronic device; or may exist alone without being assembled into the electronic device.

The above-mentioned computer-readable medium carries one or more programs, and the one or more programs, when executed by the electronic device, cause the electronic device to implement the above-mentioned method of the present disclosure.

Computer program code for performing the operations of the present disclosure may be written in one or more programming languages or a combination thereof, including an object-oriented programming language such as Java, Smalltalk, C++, and a conventional procedural programming language such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of code that includes one or more executable instructions for implementing a specified logical function. It should also be noted that, in some alternative implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The units involved in the embodiments of the present disclosure may be implemented by software or hardware. The name of a unit does not constitute a limitation on the unit itself under certain circumstances.

The functions described herein above may be performed, at least in part, by one or more hardware logic components. For example, without limitation, exemplary types of hardware logic components that can be used include: field Programmable Gate Array (FPGA), Application Specific Integrated Circuit (ASIC), Application Specific Standard Product (ASSP), System on Chip (SOC), Complex Programmable Logical device (CPLD), etc.

In the context of the present disclosure, the machine-readable medium may be a tangible medium that may contain or store a program for use by or in combination with an instruction execution system, apparatus or device. The machine-readable medium may be a machine-readable signal medium or a machine-readable storage medium. The machine-readable medium may include but is not limited to an electronic, magnetic, optical, electromagnetic, infrared, or semiconductor system, apparatus or device, or any suitable combination of the above. More examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, a method for displaying a 3D image is provided, including: performing, at an electronic device in communication with a first display generation component, a second display generation component, and an input device, the following steps: displaying, by the first display generation component and the second display generation component, a computer-generated 3D environment; detecting, by the input device, a preset operation of a user for the 3D image; invoking a target 2D application in response to the preset operation; creating a first graphics buffer corresponding to the target 2D application; obtaining a left-eye image and a right-eye image based on the 3D image, rendering the left-eye image and the right-eye image; and drawing the rendered left-eye image into the first graphics buffer based on a first layer corresponding to the first display generation component to present a picture of the left-eye image on the first display generation component through a first application interface of the target 2D application, and drawing the rendered right-eye image into the first graphics buffer based on a second layer corresponding to the second display generation component to present a picture of the right-eye image on the second display generation component through the first application interface of the target 2D application.

According to one or more embodiments of the present disclosure, the 3D image includes a 3D video; the obtaining a left-eye image and a right-eye image based on the 3D image includes: launching a 3D player through the target 2D application to parse the 3D video to obtain the left-eye image and the right-eye image.

According to one or more embodiments of the present disclosure, the method further includes: obtaining dynamic disparity information of the 3D video based on the 3D player; rendering the left-eye image and the right-eye image based on the dynamic disparity information; where the dynamic disparity information includes disparity information generated due to translation or scaling of a lens during a video capturing process.

According to one or more embodiments of the present disclosure, the target 2D application has a visual element capable of interacting with a user; the visual element is invisible when the 3D image is presented on the first application interface; the method further includes: in response to a video switching operation of the user, displaying a target video frame through the visual element and causing the visual element to perform an action corresponding to the video switching operation, and causing the first application interface to be invisible; where the target video frame is a video frame displayed by the first application interface when the video switching operation is detected; and after the video switching is completed, causing the visual element to be invisible, and causing the first application interface to be visible, and displaying an image of a switched video through the first application interface.

According to one or more embodiments of the present disclosure, the displaying the target video frame through the visual element includes: drawing the target video frame in a second graphics buffer corresponding to the visual element; the causing the first application interface to be invisible includes: hiding the first graphics buffer; the causing the visual element to be invisible includes: hiding the second graphics buffer; and the causing the first application interface to be visible and playing the switched video through the first application interface includes: setting the first graphics buffer to a display state, and drawing the image of the switched video in the first graphics buffer.

According to one or more embodiments of the present disclosure, the positions and sizes of the visual element are set to be capable of intercepting an interactive operation of the user on the first application interface.

According to one or more embodiments of the present disclosure, the video switching operation includes a drag operation on the visual element; the causing the visual element to perform the action corresponding to the video switching operation includes: moving the visual element in the 3D environment.

According to one or more embodiments of the present disclosure, an apparatus for displaying a 3D image is provided, including: a display unit, configured to display a computer-generated 3D environment; an operation detection unit, configured to detect, by the input device, a preset operation of a user for the 3D image; an application invoking unit, configured to invoke a target 2D application in response to the preset operation; a buffer creation unit, configured to create a first graphics buffer corresponding to the target 2D application; an image parsing unit, configured to obtain a left-eye image and a right-eye image based on the 3D image, an image rendering unit, configured to render the left-eye image and the right-eye image; and an image drawing unit, configured to draw the rendered left-eye image into the first graphics buffer based on a first layer corresponding to the first display generation component to present a picture of the left-eye image on the first display generation component through a first application interface of the target 2D application, and draw the rendered right-eye image into the first graphics buffer based on a second layer corresponding to the second display generation component to present a picture of the right-eye image on the second display generation component through the first application interface of the target 2D application.

According to one or more embodiments of the present disclosure, an electronic device is provided, including: at least one memory and at least one processor; where the memory is configured to store program code, and the processor is configured to invoke the program code stored in the memory to cause the electronic device to perform the method for displaying a 3D image provided according to one or more embodiments of the present disclosure.

According to one or more embodiments of the present disclosure, a non-transitory computer storage medium is provided, where the non-transitory computer storage medium stores program code, and the program code, when executed by a computer device, causes the computer device to perform the method for displaying a 3D image provided according to one or more embodiments of the present disclosure.

The above description is only preferred embodiments of the present disclosure and and an illustration of the applied technical principles. Those skilled in the art should understand that the scope of disclosure involved in this disclosure is not limited to the technical solutions formed by a specific combination of the above technical features, and should also cover other technical solutions formed by any combination of the above technical features or their equivalents without departing from the above disclosed concepts. For example, a technical solution formed by replacing the above features with technical features with similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be beneficial. Similarly, although several specific implementation details are included in the above discussion, these should not be interpreted as limiting the scope of the present disclosure. Certain features that are described in the context of separate embodiments can also be implemented in combination in a single embodiment. Conversely, various features described in the context of a single embodiment may also be implemented in multiple embodiments separately or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms for implementing the claims.

I/we claim:

1. A method, comprising:
performing, at an electronic device in communication with a first display generation component, a second display generation component, and an input device, the following steps:
displaying, by the first display generation component and the second display generation component, a computer-generated three-dimensional (3D) environment;
detecting, by the input device, a preset operation of a user for a 3D image;
invoking a target two-dimensional (2D) application in response to the preset operation;
creating a first graphics buffer corresponding to the target 2D application;
obtaining a left-eye image and a right-eye image based on the 3D image,
rendering the left-eye image and the right-eye image; and
drawing the rendered left-eye image into the first graphics buffer based on a first layer corresponding to the first display generation component to present a picture of the left-eye image on the first display generation component through a first application interface of the target 2D application, and drawing the rendered right-eye image into the first graphics buffer based on a second layer corresponding to the second display generation component to present a picture of the right-eye image on the second display generation component through the first application interface of the target 2D application.

2. The method according to claim 1, wherein the 3D image comprises a 3D video;
obtaining a left-eye image and a right-eye image based on the 3D image comprises: launching a 3D player through the target 2D application to parse the 3D video to obtain the left-eye image and the right-eye image.

3. The method according to claim 2, wherein the method further comprises:
obtaining dynamic disparity information of the 3D video based on the 3D player; and
rendering the left-eye image and the right-eye image based on the dynamic disparity information;
wherein the dynamic disparity information comprises disparity information generated due to translation or scaling of a lens during a video capturing process.

4. The method according to claim 2, wherein the target 2D application has a visual element capable of interacting with a user; the visual element is invisible when the 3D image is presented on the first application interface; and wherein
the method further comprises:
in response to a video switching operation of the user, displaying a target video frame through the visual element and causing the visual element to perform an action corresponding to the video switching operation, and causing the first application interface to be invisible; wherein the target video frame is a video frame displayed by the first application interface when the video switching operation is detected; and
after the video switching is completed, causing the visual element to be invisible, and causing the first application interface to be visible, and displaying a picture of a switched video through the first application interface.

5. The method according to claim 4, wherein
displaying the target video frame through the visual element comprises: drawing the target video frame in a second graphics buffer corresponding to the visual element;
causing the first application interface to be invisible comprises: hiding the first graphics buffer;
causing the visual element to be invisible comprises: hiding the second graphics buffer; and
causing the first application interface to be visible and playing the switched video through the first application interface comprises: setting the first graphics buffer to a display state, and drawing a picture of the switched video in the first graphics buffer.

6. The method according to claim 4, wherein a position and a size of the visual element are set to be capable of intercepting an interactive operation of the user on the first application interface.

7. The method according to claim 4, wherein the video switching operation comprises a drag operation on the visual element;
causing the visual element to perform the action corresponding to the video switching operation comprises: moving the visual element in the 3D environment.

8. An electronic device, comprising:
at least one memory and at least one processor;
wherein the memory is configured to store program code, and the processor is configured to invoke the program code stored in the memory to cause the electronic device to perform a method comprising:
displaying, by a first display generation component and a second display generation component, a computer-generated three-dimensional (3D) environment;
detecting, by an input device, a preset operation of a user for a 3D image;
invoking a target two-dimensional (2D) application in response to the preset operation;
creating a first graphics buffer corresponding to the target 2D application;
obtaining a left-eye image and a right-eye image based on the 3D image,
rendering the left-eye image and the right-eye image; and
drawing the rendered left-eye image into the first graphics buffer based on a first layer corresponding to the first display generation component to present a picture of the left-eye image on the first display generation component through a first application interface of the target 2D application, and drawing the rendered right-eye image into the first graphics buffer based on a second layer corresponding to the second display generation component to present a picture of the right-eye image on the second display generation component through the first application interface of the target 2D application.

9. The electronic device according to claim 8, wherein the 3D image comprises a 3D video;
obtaining a left-eye image and a right-eye image based on the 3D image comprises: launching a 3D player through the target 2D application to parse the 3D video to obtain the left-eye image and the right-eye image.

10. The electronic device according to claim 9, wherein the method further comprises:
obtaining dynamic disparity information of the 3D video based on the 3D player; and
rendering the left-eye image and the right-eye image based on the dynamic disparity information;
wherein the dynamic disparity information comprises disparity information generated due to translation or scaling of a lens during a video capturing process.

11. The electronic device according to claim 9, wherein the target 2D application has a visual element capable of interacting with a user; the visual element is invisible when the 3D image is presented on the first application interface; and wherein
the method further comprises:
in response to a video switching operation of the user, displaying a target video frame through the visual element and causing the visual element to perform an action corresponding to the video switching operation, and causing the first application interface to be invisible; wherein the target video frame is a video frame displayed by the first application interface when the video switching operation is detected; and
after the video switching is completed, causing the visual element to be invisible, and causing the first application interface to be visible, and displaying a picture of a switched video through the first application interface.

12. The electronic device according to claim 11, wherein
displaying the target video frame through the visual element comprises: drawing the target video frame in a second graphics buffer corresponding to the visual element;
causing the first application interface to be invisible comprises: hiding the first graphics buffer;
causing the visual element to be invisible comprises: hiding the second graphics buffer; and
causing the first application interface to be visible and playing the switched video through the first application interface comprises: setting the first graphics buffer to a display state, and drawing a picture of the switched video in the first graphics buffer.

13. The electronic device according to claim 11, wherein a position and a size of the visual element are set to be capable of intercepting an interactive operation of the user on the first application interface.

14. The electronic device according to claim 11, wherein the video switching operation comprises a drag operation on the visual element;
causing the visual element to perform the action corresponding to the video switching operation comprises: moving the visual element in the 3D environment.

15. A non-transitory computer storage medium, wherein
the non-transitory computer storage medium stores program code which, when executed by a computer device, causes the computer device to perform a method comprising:
displaying, by a first display generation component and a second display generation component, a computer-generated three-dimensional (3D) environment;
detecting, by an input device, a preset operation of a user for a 3D image;
invoking a target two-dimensional (2D) application in response to the preset operation;
creating a first graphics buffer corresponding to the target 2D application;
obtaining a left-eye image and a right-eye image based on the 3D image,
rendering the left-eye image and the right-eye image; and
drawing the rendered left-eye image into the first graphics buffer based on a first layer corresponding to the first display generation component to present a picture of the left-eye image on the first display generation component through a first application interface of the target 2D application, and drawing the rendered right-eye image into the first graphics buffer based on a second layer corresponding to the second display generation component to present a picture of the right-eye image on the second display generation component through the first application interface of the target 2D application.

16. The medium according to claim 15, wherein the 3D image comprises a 3D video;
obtaining a left-eye image and a right-eye image based on the 3D image comprises: launching a 3D player through the target 2D application to parse the 3D video to obtain the left-eye image and the right-eye image.

17. The medium according to claim 16, wherein the method further comprises:
obtaining dynamic disparity information of the 3D video based on the 3D player; and
rendering the left-eye image and the right-eye image based on the dynamic disparity information;
wherein the dynamic disparity information comprises disparity information generated due to translation or scaling of a lens during a video capturing process.

18. The medium according to claim 16, wherein the target 2D application has a visual element capable of interacting with a user; the visual element is invisible when the 3D image is presented on the first application interface; and wherein
the method further comprises:
in response to a video switching operation of the user, displaying a target video frame through the visual element and causing the visual element to perform an action corresponding to the video switching operation, and causing the first application interface to be invisible; wherein the target video frame is a video frame displayed by the first application interface when the video switching operation is detected; and
after the video switching is completed, causing the visual element to be invisible, and causing the first application interface to be visible, and displaying a picture of a switched video through the first application interface.

19. The medium according to claim 18, wherein
displaying the target video frame through the visual element comprises: drawing the target video frame in a second graphics buffer corresponding to the visual element;
causing the first application interface to be invisible comprises: hiding the first graphics buffer;
causing the visual element to be invisible comprises: hiding the second graphics buffer; and
causing the first application interface to be visible and playing the switched video through the first application interface comprises: setting the first graphics buffer to a display state, and drawing a picture of the switched video in the first graphics buffer.

20. The medium according to claim 18, wherein a position and a size of the visual element are set to be capable of intercepting an interactive operation of the user on the first application interface.
